(19) United States
(12) Patent Application Publication
(10) Pub. No.: US 2020/0234587 A1
(43) Pub. Date: Jul. 23, 2020

(54) SYSTEMS AND METHODS FOR DRIVER ASSISTANCE

(71) Applicants: TOYOTA MOTOR EUROPE, Brussels (BE); TOYOTA JIDOSHA KABUSHIKI KAISHA, Toyota-shi, Aichi-ken (JP)

(72) Inventors: Paul GIROND, Brussels (BE); Remi DELEFOSSE, Brussels (BE); Christophe GILLET, Brussels (BE); Naoki NISHIMURA, Toyota-shi (JP); Yoshiya IWAKI, Toyota-shi (JP)

(73) Assignees: TOYOTA MOTOR EUROPE, Brussels (BE); TOYOTA JIDOSHA KABUSHIKI KAISHA, Toyota-shi, Aichi-ken (JP)

(21) Appl. No.: 16/651,743

(22) PCT Filed: Sep. 29, 2017
(86) PCT No.: PCT/EP2017/074819

§ 371 Date: Mar. 27, 2020

(51) Int. Cl. G08G 1/0968; G01C 21/36; B60R 1/00; G06K 9/00

(52) U.S. Cl. CPC G08G 1/096894; G01C 21/3697; B60R 1/00; B60R 2300/804; B60R 2300/10; B60R 2300/20; B60R 2300/304; G06K 9/00818

(57) ABSTRACT

A driver assistance system for a vehicle, including optical recognition means configured to obtain data regarding a regulation indicator in proximity to the vehicle, the data comprising at least a camera-detected regulation value, location providing means configured to provide location information indicating a location of the vehicle and map information related to features in proximity to the location, the features comprising at least one of a map-based regulation value, a conditional indicator, current-link information, and next-link information, and processing means configured to verify and/or augment a display of driver assistance information based on the camera-detected regulation value, the map-based regulation value, current link information, and a presence of the conditional indicator and/or the next-link information.

### FIELD OF THE DISCLOSURE

The present disclosure is related to systems and methods for road sign display augmentation, and more particularly, to enable detection, supply, and display of supplemental road sign information for a vehicle operator or self-driving vehicle control system.

### BACKGROUND OF THE DISCLOSURE

Various systems exist for providing assistance to drivers of motor vehicles. For example, one such area of assistance relates to automated road sign recognition and display.

Road sign recognition may be accomplished by using suitable devices (e.g., optical devices such as a camera) for perceiving or detecting the surroundings of a motor vehicle. Systems are available commercially, for example, both from automobile manufacturers, and from manufacturers of portable navigation devices (PNDs). The PND systems are based on GPS signals and map data for supplying the driver with information relating to road signs.

Some existing systems implement a camera device for improving recognition accuracy and robustness. The manufacturers of vehicles use front-mounted camera devices and means for combining signals with data relating to the driving state of the vehicle. A further option is means for combining signals with navigation devices.

In such systems certain issues exist such as, for example, how long to maintain display of a particular regulation value to the driver (i.e., how long is such a value relevant), what to do when multiple indicators are recognized in succession, and how should a vehicle change in direction or crossing of an intersection affect display of the regulation value. In addition, because some portions of certain indicators may not be recognizable by a recognition device, there may be a question as to where and/or when a certain indicator is in effect.

US 2017/0092125 discloses a driving support device for detecting a speed limit sign, and displays the speed limit information conditionally for a period of time based on information provided by a vehicle navigation system.

### SUMMARY OF THE DISCLOSURE

The present inventors have recognized that certain speed limit signs may have conditions and/or restrictions, for example, as to which lane they apply and/or during what hours of the day the indicated value applies, and that image recognition systems alone may frequently be insufficient for ensuring the restriction/conditional information is displayed correctly to a driver and/or provided to a control system. Therefore, the present configurations are directed to solving this problem.

According to embodiments of the present disclosure, a driver assistance system for a vehicle is provided. The system includes optical recognition means configured to obtain data regarding a regulation indicator in proximity to the vehicle, the data comprising at least a camera-detected regulation value, location providing means configured to provide location information indicating a location of the vehicle and map information related to features in proximity to the location, the features comprising at least one of a map-based regulation value, a conditional indicator, current-link information, and next-link information, and processing means configured to verify and/or augment a display of driver assistance information based on the camera-detected regulation value, the map-based regulation value, and a presence of the conditional indicator and/or the next-link information.

During the verification and/or augmentation the processing means may be configured to determine whether the conditional indicator is present in the map information, determine whether the camera-detected regulation value and the map-based regulation value are equal, and when the camera-detected regulation value and the map-based regulation value are equal, and when the conditional indicator is present, cause the display to be updated with the camera-detected regulation value augmented with the conditional indicator.

During the verification and/or augmentation the processing means may be configured to determine from the current link information whether the vehicle is on a controlled access road, determine whether the camera-detected regulation value is less than the map-based regulation value, and when the vehicle is on a controlled access road, and the camera-detected regulation value is less than the map-based regulation value, cause the display to be updated with the camera-detected regulation value augmented with an exit lane indicator.

The processing means may be further configured to determine from the location information and the next-link information whether a next-link comprises an exit lane and whether a remaining distance of a current link on which the vehicle is travelling, as determined by the current link information, is less than a predetermined length prior to updating the display, and if either or both conditions is/are not true, causing the display of only the camera-detected regulation value.

The camera-detected regulation value and map-based regulation value may comprise speed limit values and the conditional indicator may comprise at least one of an effective time period and an exit lane indicator.

According to further embodiments of the disclosure, a method for assisting an operator of a vehicle is provided. The method includes obtaining optical data regarding a regulation indicator in proximity to the vehicle, the optical data comprising at least a camera-detected regulation value, providing location information indicating a location of the vehicle and map information regarding features in proximity to the location, the features comprising at least one of a map-based regulation value, a conditional indicator, current link information, and a next-link information, and verifying and/or augmenting a display of driver assistance information based on the camera-detected regulation value, the map-based regulation value, and a presence of the conditional indicator and/or the next-link information.

The verifying and/or the augmenting may include determining whether the conditional indicator is present in the map information, determining whether the camera-detected regulation value and the map-based regulation value are equal, and when the camera-detected regulation value and the map-based regulation value are equal, and when the conditional indicator is present, displaying the camera-detected regulation value augmented with the conditional indicator on a display device.

In addition, a second condition for displaying the camera-detected regulation value augmented with the conditional indicator may be that the map-based regulation value is linked to the conditional indicator.

The verifying and/or the augmenting may include determining from the current link information whether the vehicle is on a controlled access road, determining whether the camera-detected regulation value is less than the map-based regulation value, and when the vehicle is on a controlled access road, and the camera-detected regulation value is less than the map-based regulation value, displaying the camera-detected regulation value augmented with an exit lane indicator to the operator.

The method may include determining from the location information and the next-link information whether a next-link comprises an exit lane and whether a remaining distance of a current link on which the vehicle is travelling, as determined by the current link information, is less than a predetermined length prior to the displaying, and if at least one condition is not true, causing the display of only the camera-detected regulation value.

The camera-detected and map-based regulation values may comprise speed limits and the conditional indicator may comprise one of an effective time period (e.g., during snow, rain, darkness, etc.) or an exit lane indicator.

According to yet further embodiments of the present disclosure, a vehicle comprising the driver assistance system described above is provided.

It is intended that combinations of the above-described elements and those within the specification may be made, except where otherwise contradictory.

It is to be understood that both the foregoing general description and the following detailed description are exemplary and explanatory only and are not restrictive of the disclosure, as claimed.

The accompanying drawings, which are incorporated in and constitute a part of this specification, illustrate embodiments of the disclosure and together with the description, serve to explain the principles thereof.

### BRIEF DESCRIPTION OF THE DRAWINGS

FIG. 1 shows an exemplary driver assistance system according to embodiments of the present disclosure;

FIG. 2 shows a vehicle on an exemplary road segment having a regulation indicator and conditional information;

FIGS. 3A-3D show actual, camera detected, map based, and displayed regulation indicators and conditional information, according to embodiments of the present disclosure;

FIG. 4 is a flowchart highlighting an exemplary method according to embodiments of the disclosure;

FIG. 5A shows an exemplary controlled access road having a regulation indicator and explicit conditional information;

FIG. 5B shows an exemplary controlled access road having a regulation indicator and implicit conditional information;

FIG. 5C shows actual, camera-detected, and displayed regulation indicator and conditional information, according to embodiments of the present disclosure;

FIG. 6 is a flowchart highlighting another exemplary method according to embodiments of the disclosure; and

FIG. 7 is an illustration to aid in the comprehension of current and next links.

### DESCRIPTION OF THE EMBODIMENTS

Reference will now be made in detail to exemplary embodiments of the disclosure, examples of which are illustrated in the accompanying drawings. Wherever possible, the same reference numbers will be used throughout the drawings to refer to the same or like parts.

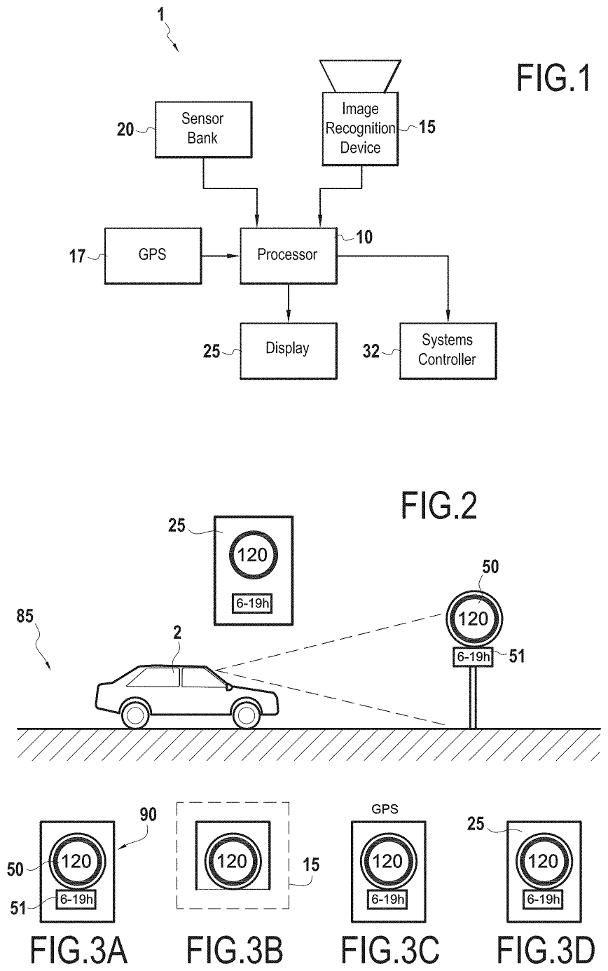

FIG. 1 shows an exemplary driver assistance system 1 according to embodiments of the present disclosure. The driver assistance system 1 may include processing means, such as an electronic control unit (ECU) 10, image obtaining means 15 such as a camera, one or more sensors 20, systems controller 32, and a display 25 among others.

A global positioning system (GPS) 17, corresponding to a location providing means, is also provided for providing map data (e.g., location information such as coordinates) regarding location of the vehicle and feature information regarding features (e.g., regulation indicators, current link information, next link information, for example, an exit lane, etc.) in proximity to the vehicle.

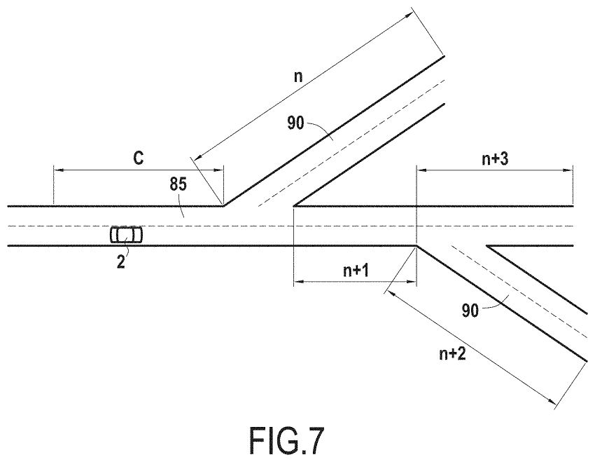

FIG. 7 is an illustration to aid in the comprehension of current links 75 and next links 90. Map data may be broken into portions of a Current Link C, 85 (e.g., the portion of road, for example a length of 500 m, upon which vehicle 2 is currently traveling) and Next Links N, 90 (e.g., the portion or portions of road over which the vehicle could be travelling over a forthcoming distance, i.e., any possible intersection/road segment outside of the exemplary 500 m Current Link information). The length of each link may be predetermined based, for example, the GPS software used, internal logic of vehicle 2, etc. Information associated with these links may include, for example, road class (e.g., controlled access highway, rural route, etc.), exit ramps, road works, traffic signals, directional indicators, etc.

Image obtaining means 15, corresponding to an optical recognition means, may include, for example, one or more cameras and/or other suitable devices configured to obtain optical data from an area surrounding a vehicle (e.g., in front of a forward moving vehicle). Image obtaining means 15 may be configured to process the data obtained from the surroundings of the vehicle to determine the existence of regulation indicators 50 (e.g., road signs such as a speed limit sign, a zone indicator sign, among others). Such image obtaining means 15 are known in the art, and one of skill in the art will understand that any such image obtaining means 15 may be implemented in the present system without departing from the scope of the present disclosure.

Image obtaining means 15 may be located on a vehicle 2 so as to provide an adequate field of view 4 of the surroundings of the vehicle 2 (e.g. a front and side view spanning approximately 180 degrees). For example, one or more image obtaining means 15 may be located behind the windshield, on a front bumper, a side view mirror, rearview mirror, and/or other suitable mounting location on the vehicle 2 so as to provide a field of view 4 of approaching regulation indicators 50 near the vehicle, including those for an exit lane (i.e., off ramp) of the presently driven motorway. According to some embodiments it may be desirable to minimize visibility of image obtaining means 15 for aesthetic reasons, and one of skill in the art will understand that finding a mounting location suitable to achieve this goal while also providing adequate field of view surrounding the vehicle 2 to be a reasonable consideration.

The term “adequate” when referring to field of view as used herein shall mean a field of view providing image obtaining means 15 with the ability to identify regulation indicators 50 present on the road surrounding the moving vehicle and to display information related to said regulation indicators to a driver of the vehicle on display 25 with a success rate for identification of at least 95 percent.

Image obtaining means 15 may be configured to provide data regarding surroundings of a vehicle 2, including regulation indicators 50 to ECU 10. Such data may include, for example a regulation value (e.g. a speed limit and/or a zone indicator). Image obtaining means 15 may provide such data to ECU 10 via a wired connection, a wireless connection, or other suitable method for transferring data to ECU 10. For example, image obtaining means 15 may include wireless communication means (e.g. IEEE 802.11 compliant Wi-Fi hardware) for transmitting data to ECU 10 and/or other devices that may use the data from image obtaining means 15. Alternatively or in addition, for example for safety purposes, a wired connection may be provided. Such a wired connection may be provided, for example, to provide failsafe in a case where a wireless connection should cease to function.

When obtaining data related to a regulation indicator, image obtaining means 15 may be configured to assign a time indicator (e.g., a timestamp) and/or position indicator (e.g., coordinate information) to the data. Alternatively, ECU 10 may be configured to assign a time indicator to the data upon receipt from image obtaining means 15. By assigning a time indicator to data obtaining by image obtaining means 15, an age of the data (i.e., time elapsed since a regulation indicator was identified by image obtaining means 15) may be tracked by ECU 10, among others.

One or more sensors 20 may be configured to transmit state information related to a state of the vehicle to ECU 10. For example, a state of the vehicle may include a speed at which the vehicle is traveling, a direction in which the vehicle is traveling, a change of direction which the vehicle is undergoing and/or has undergone, a position of the steering wheel, a distance which the vehicle has traveled, etc.

Therefore, one or more sensors 20 may include, for example, a steering wheel position sensor, a vehicle speed sensor, a yaw rate sensor, among others. Such sensors, similarly to image obtaining means 15, may be configured to provide such state information wirelessly and/or by wire to ECU 10, and may further include duration information. Duration information associated with the state information may be tracked by ECU 10.

ECU 10 may include any suitable device configured to manipulate data, perform calculations, execute code for decision making, causing display of information to an operator of vehicle 2, and/or cause control of systems controller 32 to take action on one or more systems (e.g., steering, braking, etc.) of vehicle 2, in order to carry out embodiments of the present disclosure. For example ECU 10 may include various analog and/or digital circuits, and may include integrated circuits such as RISC processors, i386 processors, ASIC processors, etc. Typically, on-board computers in modern vehicles include such processors, and one of skill will understand that the present ECU 10 may be comprised by such an on-board computer, or may be separately provided. One of skill in the art will also understand that the exemplary circuits and processors described herein are not intended to be limiting, and that any suitable device may be implemented.

ECU 10 may be linked to one or more databases and/or other memory (e.g., RAM, ROM, etc.) associated with vehicle 2 so as to enable storage of vehicle related data as well as values that may be utilized during processing of vehicle functions (e.g., threshold values), such as regulation indicator validation. One of skill in the art will recognize that information discussed herein with regard to any such databases and/or memory is not intended to be limiting.

ECU 10 may be configured to receive data from image obtaining means 15 and providing functionality associated with the present disclosure. For example ECU 10 may receive data regarding regulation indicators from image obtaining means 15 and one or more sensors simultaneously (e.g., streaming data). Such data may include, for example, a speed limit, and/or intersection information.

ECU 10 may further be configured to receive data from GPS 17, the data including location information and map information related to features in proximity to the location of the vehicle 2. Location information may include, for example, global coordinates enabling fixing/determining of a position of vehicle 2 on a map, current and next link information indicating a link on which the vehicle 2 currently travels (i.e., current link) and possible future travel paths (i.e., next links), as well as information regarding these current and next links (e.g., controlled access highway, city zone, among others), etc.

Features included in map information may comprise, for example, speed limit signs featuring a regulated speed limit indication, exit lanes, conditional indicators (e.g., hours of activation, prohibited hours, weather condition, seasonal, etc.), topography, etc. One of skill will recognize that more or fewer features may be present in the map information as desired, the level of detail being dependent upon, for example, map information provider, among others. One of skill will further recognize that GPS 17 may form part of ECU 10, may be separate from ECU 10, or any level of combination between GPS 17 and ECU 10 may be implemented without departing from the scope of the present disclosure.

ECU 10 may be linked to one or more interfaces, e.g. network interfaces, which may be configured to receive wirelessly and/or by wire the data and information provided by image obtaining means 15, GPS 17, sensors 20, among others. Further, while the GPS 17 is described as present on vehicle 2, one of skill will understand that certain map data including features of the current and next links, may be stored remotely and transmitted to GPS 17 and/or ECU 10, for example, via 4G, such that up to date information is available.

According to some embodiments, vehicle 2 may include one or more system controllers 32, which may be configured to receive information and/or commands from ECU 10, and to execute those commands to control various vehicle systems (e.g., steering, braking, accelerator, etc.). Such devices may be configured to actively manipulate control systems 32 of vehicle 2, for example, to operate a steering system, a braking system, an acceleration system, etc.

Such devices may include one or more servo motors, actuators, etc., which may receive instructions from one or more systems of vehicle 2, for example ECU 10. Based on these instructions, vehicle 2 may be controlled by an operator, ECU 10 in combination with system control 32, or both simultaneously (e.g., system controller 32 providing steering and braking assistance in a panic stop situation).

Display 25 may be configured to display information provided by ECU 10 to a driver of vehicle 2. FIG. 2 shows an exemplary display 25 providing information that may be of interest to a driver of vehicle 2. As shown at FIG. 2, a valid speed limit is among the information currently displayed to a driver on display 25.

Display 25 may be any suitable device for providing visible and/or audible information to a driver of vehicle 2. For example, display 25 may include a heads up display (e.g., on a windshield in front of a driver), a monitor, an in-dash display, etc.

Based on based on the camera-detected regulation value obtained by image obtaining means 15, a map-based regulation value provided by GPS 17, and a conditional indicator, current link, and/or the next-link information provided to ECU 10, ECU 10 may be configured to perform various operations for displaying, updating, and/or augmenting a display of information to an operator of vehicle 2.

For purposes of explaining a first embodiment of the present disclosure an example using a speed limit sign 50 augmented with conditional indications 51 of an effective time period will be described. A second example, again using a speed limit sign, but in view of an exit lane as a conditional indicator on a controlled access highway will be described. One of skill in the art will understand, however, that these are merely exemplary and not intended to be limiting.

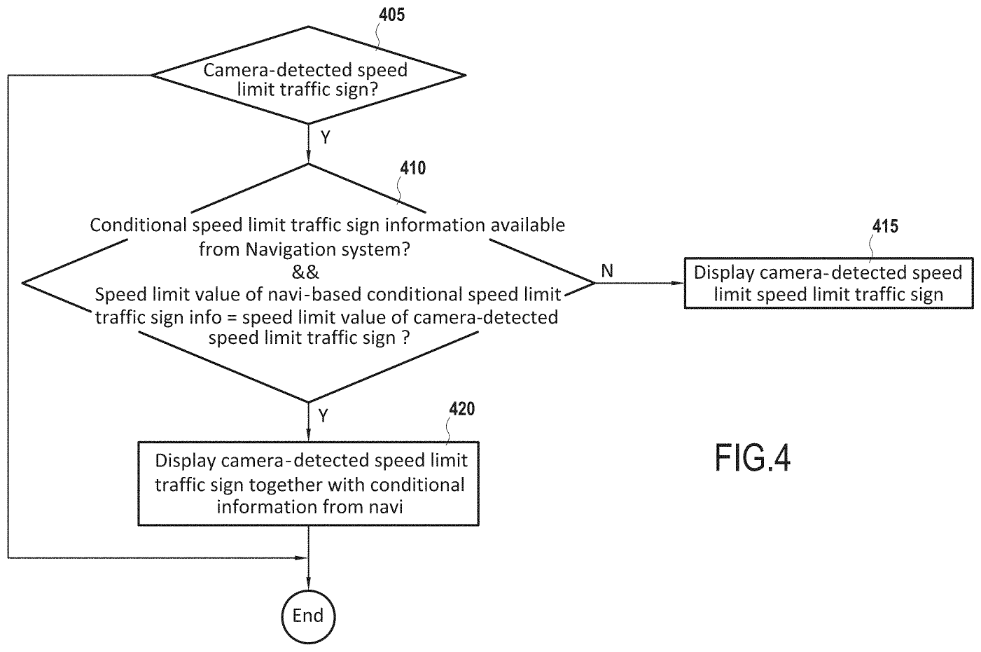

FIG. 4 is a flowchart highlighting an exemplary method for carrying out embodiments of the present disclosure and may be better understood by referring also to FIGS. 3A-C.

As vehicle 2 travels along a current link segment 85 image obtaining means 15 may detect various regulation indicators, among them, for example, speed limit signs 90 (step 405). When a newly identified regulation indicator 50 has been detected, for example, an indicator 50 having a conditional indicator 51 as shown at FIG. 3A, ECU 10 and/or image obtaining means 15 may determine whether the regulation indicator 50 is a speed limit sign indicating a regulation value, and if not, disregard the regulation indicator 50 for purposes of the present disclosure (step 405: no). One of skill will understand that other actions may be undertaken in the context of other desirable operations with regard to a regulation indicator 50 not processed under embodiments of the present disclosure.

When a regulation indicator 50 indicating a speed limit is detected by image obtaining means (step 405: yes), typically image obtaining means 15 perceives primarily just the speed limit indication, as as shown at FIG. 3B, enabling determination of speed limit regulation value. The ECU 10 may then perform the next check of validating the camera-detected speed limit and determining whether conditional information is present for a present location of vehicle 2 (step 410). In order to validate the camera-detected speed limit value, the speed limit value determined from the regulation indicator 50 obtained by image obtaining means 15, is compared with a map-based speed limit value obtained from features (i.e., a regulation value) stored in map information associated with GPS 17 for the current link 85 on which vehicle 2 is travelling. The features in map information available from GPS 17 generally include the information depicted by FIG. 3C, among others, for example. If the regulation value determined from regulation indicator 50 captured by image obtaining means 15 is not equal to the value obtained from GPS 17 for the current link 85 (step 410: no) then ECU 10 causes display 25 to display only the value determined from regulation indicator 50 (step 415) as received from image obtaining means 15.

If the regulation value determined from regulation indicator 50 captured by image obtaining means 15 is equal to the value obtained from GPS 17 for the current link 85, then ECU 10 checks to determine whether a conditional indicator is present for the regulation indicator 50, based on the location of vehicle 2 as determined by GPS 17. For example, as shown at FIG. 2, a regulation value of 120 km/h is in effect on current link 85 every day during the hours of 09:00 to 19:00, a situation which one of skill will recognize as exemplary and not limiting.

Features stored in map information of GPS 17 should reflect this conditional indication, and when determined by ECU 10 that such a conditional indicator exists (step 410: yes) display 25 is augmented to display both the validated speed limit and the conditional indicator as shown at FIG. 3D (step 420). In addition, when, for example, indicated by an operator of vehicle 2, ECU 10 may cause vehicle control systems 32 to operate the vehicle such that the vehicle speed matches (or to within a desired pre-specified range, e.g., 5 percent) the indicated value.

As noted, one of skill will recognize that the example described above is not intended to be limiting. A conditional indicator may be, for example, an indicator showing effective days of the week, effective weather conditions, effective seasons (e.g., winter and spring only), etc. or any combination of conditional indicators (e.g., 5:00-9:00 on school days). Any such configuration is intended to fall within the scope of the present disclosure.

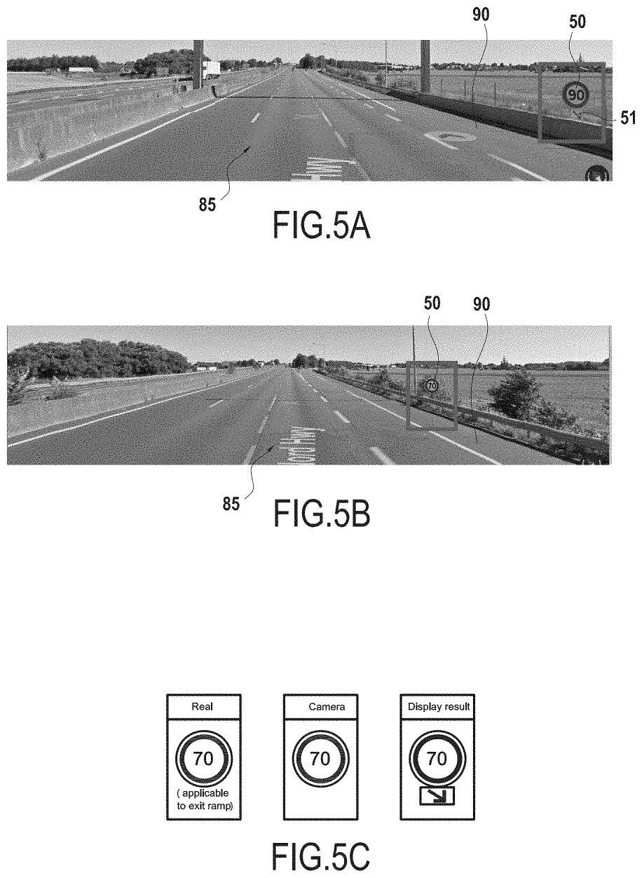

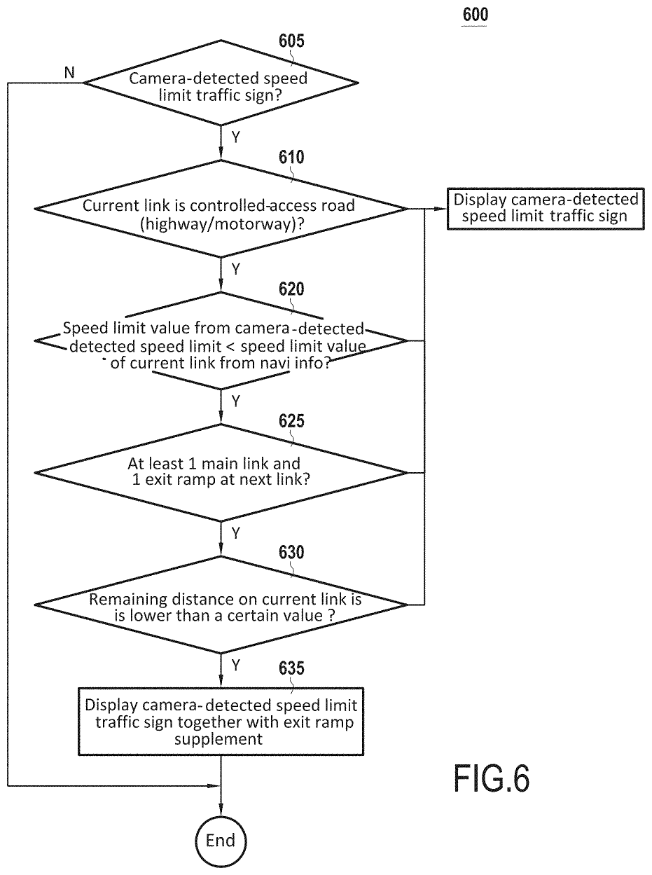

Turning to FIGS. 5A-C and 6, a second embodiment of the present disclosure will be described. Vehicle 2 may be traveling on a current link 85 as shown at FIG. 5A, and a regulation indicator 50 may be detected my image obtaining means 15 (step 605). In the present example, the regulation indicator 50 is associated with an exit lane 90 from the controlled access highway which comprises current link 85. As shown in FIG. 5A conditional indicator 51 is also present with regulation indicator 50, conditional indicator 51 indicating explicitly that the regulation indicator 50 applies to the exit lane 90 from the controlled access highway. Alternatively as shown in FIG. 5B, regulation indicator 50 may not include conditional indicator 51, however, an operator of the vehicle understands that based on the placement of regulation indicator 50, this regulation indicator implicitly applies to exit lane 90.

When a regulation indicator 50 is detected by image obtaining means 15 (step 605: yes) ECU 10 may request map information from GPS 17 related to current link 85 to determine whether current link 85 is a controlled access road (e.g. an highway, a freeway, a motorway, etc.). Such information is generally stored in feature information stored in GPS 17 associated with the map information. If it is determined that the vehicle is not currently traveling I controlled access road (step 610: no) then ECU 10 causes display 25 display the regulation indicator as detected by image obtaining means 15 (step 615).

If, based on features stored in the map information from GPS 17, it is determined that vehicle 2 is traveling on a controlled access road (step 610: yes) then ECU 10 checks to determine whether a camera-detected regulation value associated with the regulation indicator 50 is less than a map-based regulation value associated with current link 85 as determined from map information based on location information of vehicle 2 obtained from GPS 17 (step 620).

If the map-based regulation value is not less than the camera-detected regulation value detected by image obtaining means 15 (step 620: no), this means that a new speed limit is in effect for the controlled access road, and display 25 is updated to display the camera-detected regulation value (step 615). If the map-based regulation value is less than the camera-detected regulation value (step 620: yes) then ECU 10 checks whether based on current link 85 in any next links available from GPS 17 whether an exit ramp from the controlled access road is in the vicinity of the vehicle 2 based on the location information (step 625) if no exit ramp is found either on current link 85 or on the next link (step 625: no), then the camera-detected regulation value is a new speed limit value for the controlled access road, and camera-detected regulation value is displayed on display 25. If current link 85 or a next link on which the vehicle may travel includes an exit ramp 90 (step 625: yes) then an optional step may be carried out in order to determine a distance remaining on the current link 85 to see if the distance is less than a threshold value (e.g. 250 meters). Where this optional step is not carried out or when it is determined that the remaining distance is less than the threshold value (step 630: yes), then display 25 is updated to display the camera-detected regulation value detected by image obtaining means 15 and augmented with a conditional indicator that the regulation value (i.e. the speed limit) applies only to the exit ramp 90 (step 635) as shown at the far right representation of FIG. 5C. Alternatively or in addition, ECU 10 may determine based on information provided by GPS 17 whether vehicle is likely to utilize the exit ramp 90, and cost system controllers 32 to take appropriate action to limit the speed of vehicle 2 when vehicle 2 enters exit ramp 90.

Where optional step 630 is carried out and it is determined that the remaining distance on current link 85 is greater than the threshold value, then display 25 is cause the display of the camera-detected regulation value as detected by image obtaining means 15 without any conditional indicator (step 615).

Throughout the description, including the claims, the term “comprising a” should be understood as being synonymous with “comprising at least one” unless otherwise stated. In addition, any range set forth in the description, including the claims should be understood as including its end value(s) unless otherwise stated. Specific values for described elements should be understood to be within accepted manufacturing or industry tolerances known to one of skill in the art, and any use of the terms “substantially” and/or “approximately” and/or “generally” should be understood to mean falling within such accepted tolerances.

Where any standards of national, international, or other standards body are referenced (e.g., ISO, etc.), such references are intended to refer to the standard as defined by the national or international standards body as of the priority date of the present specification. Any subsequent substantive changes to such standards are not intended to modify the scope and/or definitions of the present disclosure and/or claims.

Although the present disclosure herein has been described with reference to particular embodiments, it is to be understood that these embodiments are merely illustrative of the principles and applications of the present disclosure.

It is intended that the specification and examples be considered as exemplary only, with a true scope of the disclosure being indicated by the following claims.

1. A driver assistance system for a vehicle, comprising:
optical recognition means configured to obtain data regarding a regulation indicator in proximity to the vehicle, the data comprising at least a camera-detected regulation value;
location providing means configured to provide location information indicating a location of the vehicle and map information related to features in proximity to the location, the features comprising at least one of a map-based regulation value, a conditional indicator, current-link information, and next-link information; and
processing means configured to verify and/or augment a display of driver assistance information based on the camera-detected regulation value, the map-based regulation value, and a presence of the conditional indicator and/or the next-link information.

2. The driver assistance system according to claim 1, wherein during the verification and/or augmentation the processing means is configured to:
determine whether the conditional indicator is present in the map information;
determine whether the camera-detected regulation value and the map-based regulation value are equal; and
when the camera-detected regulation value and the map-based regulation value are equal, and when the conditional indicator is present, cause the display to be updated with the camera-detected regulation value augmented with the conditional indicator.

3. The driver assistance system according to claim 1, wherein during the verification and/or augmentation the processing means is configured to:
determine from the current link information whether the vehicle is on a controlled access road;
determine whether the camera-detected regulation value is less than the map-based regulation value; and
when the vehicle is on a controlled access road, and the camera-detected regulation value is less than the map-based regulation value, cause the display to be updated with the camera-detected regulation value augmented with an exit lane indicator.

4. The driver assistance system according to claim 3, wherein the processing means is further configured to determine from the location information and the next-link information whether a next-link comprises an exit lane and whether a remaining distance of a current link on which the vehicle is travelling, as determined by the current link information, is less than a predetermined length prior to updating the display, and if either or both conditions is/are not true, causing the display of only the camera-detected regulation value.

5. The driver assistance system according to claim 1, wherein the camera-detected and map-based regulation values are speed limit values and the conditional indicator comprises at least one of an effective time period and an exit lane indicator.

6. A method for assisting an operator of a vehicle, comprising:
obtaining optical data regarding a regulation indicator in proximity to the vehicle, the optical data comprising at least a camera-detected regulation value;
providing location information indicating a location of the vehicle and map information regarding features in proximity to the location, the features comprising at least one of a map-based regulation value, a conditional indicator, current link information, and a next-link information; and
verifying and/or augmenting a display of driver assistance information based on the camera-detected regulation value, the map-based regulation value, and a presence of the conditional indicator and/or the next-link information.

7. The method according to claim 6, wherein the verifying and/or the augmenting comprises:
determining whether the conditional indicator is present in the map information;
determining whether the camera-detected regulation value and the map-based regulation value are equal; and
when the camera-detected regulation value and the map-based regulation value are equal, and when the conditional indicator is present, displaying the camera-detected regulation value augmented with the conditional indicator on a display device.

8. The method according to claim 6, wherein the verifying and/or the augmenting comprises:
determining from the current link information whether the vehicle is on a controlled access road;
determining whether the camera-detected regulation value is less than the map-based regulation value; and
when the vehicle is on a controlled access road, and the camera-detected regulation value is less than the map-based regulation value, displaying the camera-detected regulation value augmented with an exit lane indicator to the operator.

9. The method according to claim 8, comprising determining from the location information and the next-link information whether a next-link comprises an exit lane and whether a remaining distance of a current link on which the vehicle is travelling, as determined by the current link information, is less than a predetermined length prior to the displaying, and if at least one condition is not true, causing the display of only the camera-detected regulation value.

10. The method according to claim 6, wherein the camera-detected and map-based regulation values are speed limits and the conditional indicator comprises one of an effective time period or an exit lane indicator.

11. A vehicle comprising the driver assistance system according to claim 1.
